(19) United States
(12) Patent Application Publication
(10) Pub. No.: US 2012/0103888 A1
(43) Pub. Date: May 3, 2012

(54) WASTE WATER RECYCLING SYSTEM

(75) Inventor: Karl K. Holt, Hartland, WI (US)

(73) Assignee: AERO-STREAM, LLC, Hartland, WI (US)

(21) Appl. No.: 13/375,744

(22) PCT Filed: Jun. 2, 2010
(86) PCT No.: PCT/US10/37092

§ 371 Date: Jan. 13, 2012

Related U.S. Application Data
(60) Provisional application No. 61/183,299, filed on Jun. 2, 2009.

(51) Int. Cl. C02F 1/78

(52) U.S. Cl. 210/205

(57) ABSTRACT

A wastewater treatment system comprising a first chamber adapted to receive wastewater and arranged to perform a first treatment process (e.g., aerobic and/or anaerobic processes), a second chamber positioned to receiving wastewater from the first chamber and including an ozone contactor assembly that infuses ozone into the second chamber, and a storage tank positioned to receive treated water from the second chamber. The ozone contactor assembly comprises a first conduit having an intake, a discharge, a downwardly-angled portion, and an upwardly-angled portion (e.g., U-shaped). An ozone generator is positioned to provide ozone to a lower portion of the first conduit (preferably near the bottom of both the downwardly- angled portion and the upwardly-angled portion). The ozone contactor assembly can include additional conduits structured similar to the first conduit and feeding into each other, and each including an ozone generator. The downwardly-angled and upwardly-angled portions are preferably substantially vertical.

### BACKGROUND

Historically wastewater generated from rural sources such as homes and industry has been treated and distributed into the ground utilizing a septic system (anaerobic process). In more recent years, the wastewater from these sources has been treated aerobically. The vast majority of these aerobic systems distribute the effluent below grade through a system of perforated pipes. As the effluent seeps through the soil, micro-organisms in the soil digest pathogens so when the water mixes with the ground water it is safe for human consumption. In some states and countries, the effluent can be discharged on the ground surface. Some areas that allow surface discharge require disinfection by chlorination or UV light. As fresh water becomes a higher valued commodity, many states and countries now allow water recycling of wastewater for uses such as flushing commodes, irrigation, car washing and the like.

### SUMMARY OF THE INVENTION

The present invention provides a wastewater treatment system comprising a first chamber adapted to receive wastewater and being arranged to perform a first treatment process (e.g., aerobic and/or anaerobic processes), a second chamber positioned to receiving wastewater from the first chamber and including an ozone contactor assembly that infuses ozone into the second chamber and produces treated water, and a storage tank positioned to receive treated water from the second chamber and hold it for re-use.

In one embodiment, the ozone contactor assembly comprises a first conduit having an intake, a discharge, a downwardly-angled portion, and an upwardly-angled portion (e.g., U-shaped). An ozone generator is positioned to provide ozone to a lower portion of the first conduit. Preferably, ozone is provided near the bottom of both the downwardly-angled portion and the upwardly-angled portion. The ozone contactor assembly can include additional conduits (e.g., second conduit, third conduit, etc.) structured similar or identical to the first conduit, and each including an ozone generator. In this embodiment, the discharge from the first conduit would be connected to the intake of the second conduit, and so on, such that each conduit feeds into the next conduit. In this way, the contact time between the wastewater and the ozone is enhanced. In a preferred embodiment, the downwardly-angled portion and upwardly-angled portion are each substantially vertical, such that the conduit is substantially U-shaped.

### BRIEF DESCRIPTION OF THE DRAWINGS

FIG. 1 is a schematic view of a wastewater recycling system.

FIG. 2 is a schematic view of a second embodiment of a wastewater recycling system.

FIG. 3 is a schematic of an ozone contactor assembly embodying aspects of the present invention.

FIG. 4 is a side section view of a wastewater recycling system embodying aspects of the present invention.

FIG. 5 is a perspective view of an ozone contactor assembly from the system of FIG. 4.

FIG. 6 is a side section view of a portion of an alternate embodiment of a wastewater recycling system incorporating the ozone contactor assembly of FIG. 5.

FIG. 7 is a side section view of an alternate embodiment of a wastewater recycling system incorporating the ozone contactor assembly of FIG. 5 with an inlet baffle.

### DETAILED DESCRIPTION OF EMBODIMENTS OF THE INVENTION

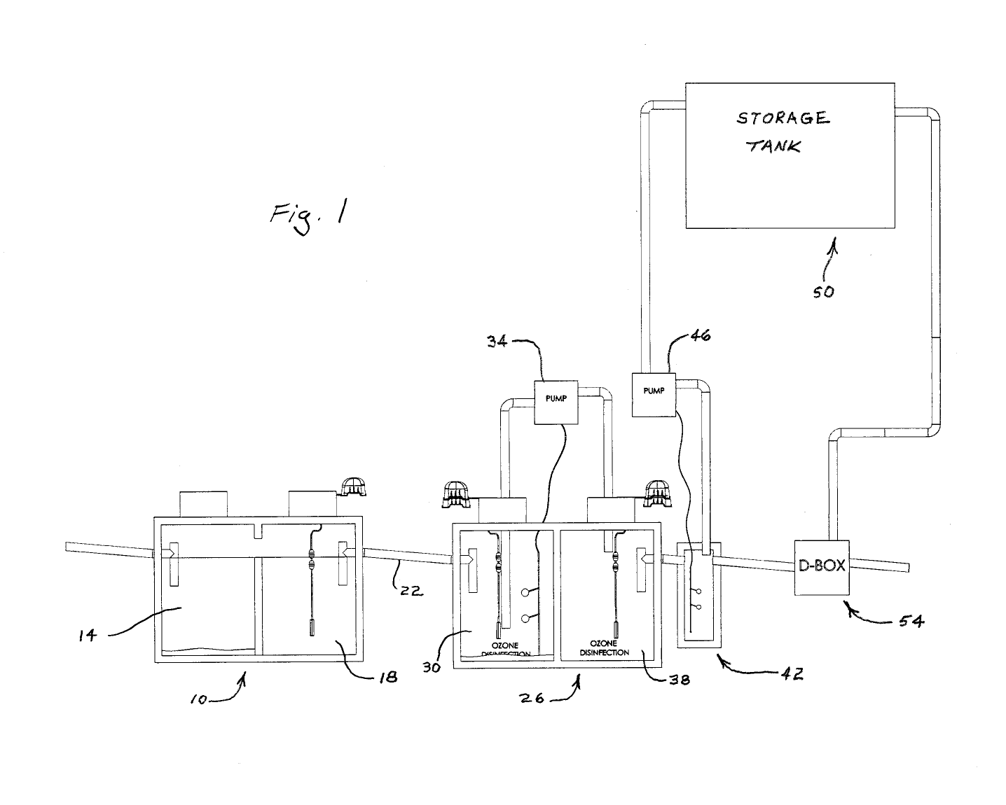

The wastewater recycling system of FIG. 1 utilizes a combination of anaerobic processes, aerobic processes and disinfection by ozone processes, or any combination of processes. This design utilizes five chambers and a holding tank for re-use. This configuration includes a 1200 gallon, 2-chamber concrete tank 10. The first chamber is a 600 gallon trash chamber 14 that separates large solids from the wastewater utilizing an anaerobic process. The wastewater then flows to a second 600 gallon chamber 18. This chamber utilizes an Aero-Stream® aerobic process with bio-brush™ technology, available from Aero-stream, LLC of Hartland, Wis. The organic strength and suspended solids are reduced by 95% and 70%, respectively.

The wastewater flows through an Aero-Stream® four inch passive bristle effluent filter 22 to a second 1200 gallon, 2-chamber concrete tank 26. The first 600 gallon chamber 30 of this tank 26 has an Aero-Pure AP1000 ozone generator (available from Aero-Stream LLC) with an output of 1 g/hour diffusing ozone into the wastewater through a porous micro-bubble diffuser. This chamber 30 also contains a system of float switches controlling a liquid transfer pump 34. The process piping has a venturi eductor to dissolve ozone into the water as the pump 34 operates. As the wastewater level rises to a prescribed depth, the float switch turns the liquid pump 34 on, transferring the wastewater to the second 600 gallon chamber 38. When the wastewater level drops to a prescribed depth, the liquid transfer pump 34 is shut down. This process repeats based on wastewater flow rate from the dwelling or source. The second chamber 38 of this tank 26 has an Aero-Pure AP1000 ozone generator with an output of 1 g/hour diffusing ozone into the wastewater through a porous micro-bubble diffuser. This chamber 38 flows by gravity into a 100 gallon pump basin 42.

This basin 42 also contains a system of float switches controlling a liquid transfer pump 46. The process piping has a venturi eductor to dissolve ozone into the water as the pump 46 operates. If enabled, this pump 46 will transfer the water from the pump basin 42 to a 1000 gallon concrete holding tank 50. This water can be recycled back into the home for commode flushing, used for irrigation or other non-human ingestion uses. If the holding tank 50 is full, the water will flow by gravity to a distribution box 54 for sub grade dispersion. If the pump 46 in the basin 42 is disabled, the water will flow by gravity directly to the distribution box 54 for sub grade dispersal.

This process can be enhanced and expanded by additional treatment chambers and ozone generators. The wastewater is batched through the disinfection process to minimize bacteria carry-over from chamber to chamber. The specific tank sizes, configurations, and materials are given by way of example only, and other tank sizes, configurations, and materials can be used. Likewise the specific ozone generators, filters, and other components described are given by way of example only. Other components can be also be used.

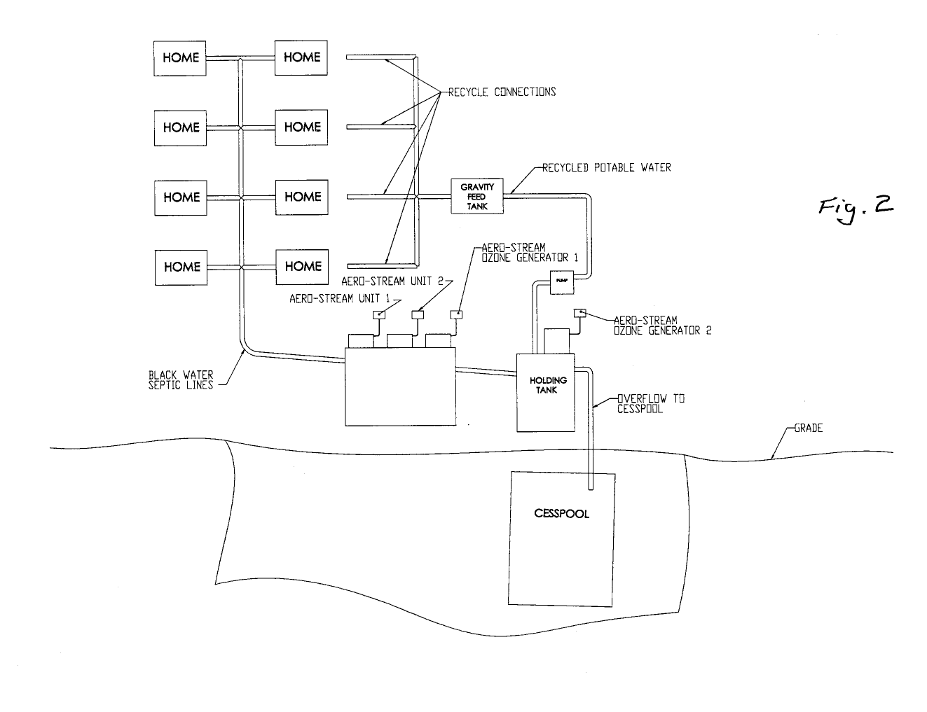

Other system configurations are also contemplated. For example, FIG. 2 illustrates an alternative system configuration.

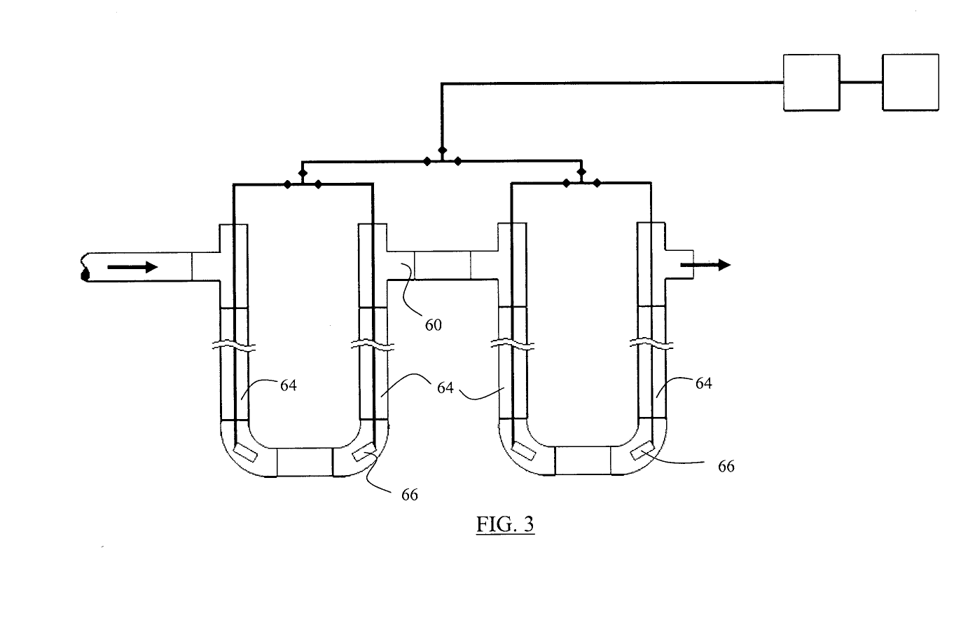

FIG. 3 illustrates another optional passive method to apply ozone to wastewater that can be used alone or in combination with the systems shown in FIGS. 1 and 2. The passive method involves increasing the contact time the wastewater has with ozone. Anaerobically or aerobically treated wastewater flows into a series of tees 60 and drop legs 64. Each drop leg 64 has an ozone diffuser 66 located near the bottom of the leg 64. As the wastewater passes through each leg 64, micro-organisms are destroyed by the ozone. The outlet of this design could be discharged by gravity to grade, sub-grade, or into a pump chamber or basin to be distributed by a liquid transfer pump. The system capacity can be expanded by increasing the quantity of drop legs 64 in series.

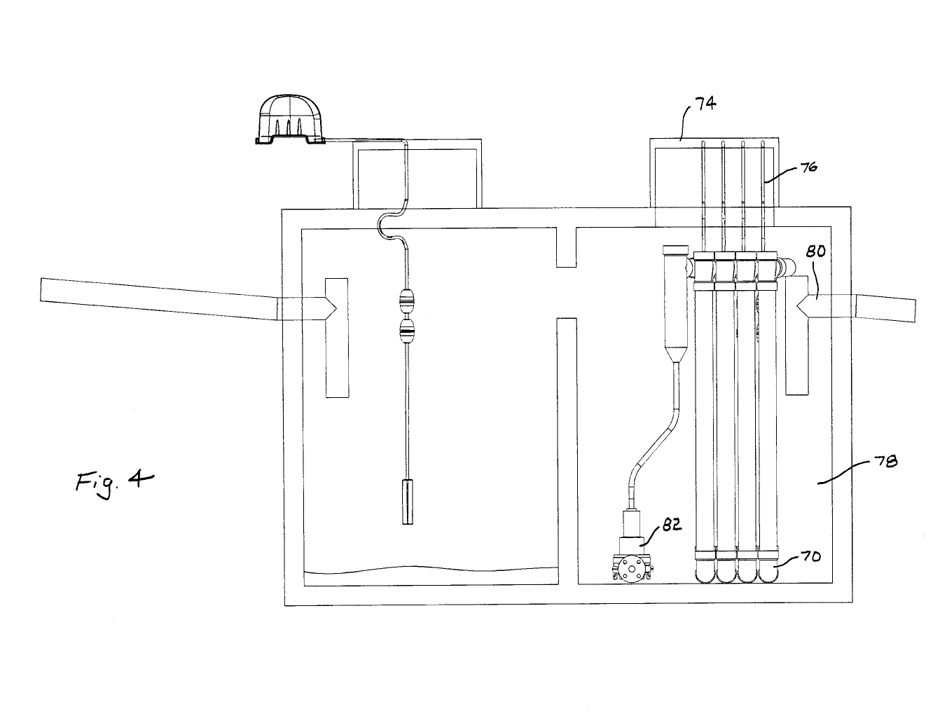

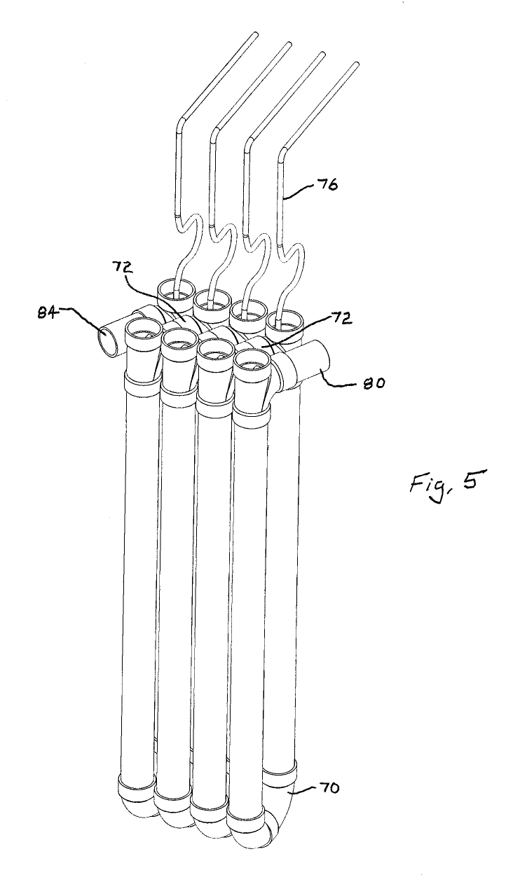

FIGS. 4 and 5 illustrate another optional method to utilize ozone to treat wastewater that can be used alone or in combination with the systems shown in FIGS. 1 and 2. This method involves increasing the contact time the wastewater has with the ozone by improving the delivery method of the ozone to the wastewater. A plurality of U-shaped chambers 70 that are interconnected by horizontal runs 72 at the top of the U shape is constructed. Each U shaped chamber receives ozone via an ozone generator 74 that transfers the ozone to the bottom of the U shaped chamber via tubes 76 and is connected to a porous micro-bubble diffuser (not shown in FIGS. 4 and 5). This system of U-shaped, interconnected compartments each containing a dedicated ozone supply and micro-bubble diffuser, heretofore referred to as an Ozone Contactor Assembly, is placed inside a septic tank compartment 78 and oriented so that the discharge 80 from the Ozone Contactor Assembly aligns with the discharge pipe of the septic tank compartment. A pump 82 and float switch (not shown) are installed in the compartment 78 so that the pump 82 provides wastewater to the opening 84 of the first U shaped compartment of the Ozone Contactor Assembly (opposite of the discharge pipe of the system—see FIG. 5). When the waste water level rises to a point that actuates the float switch, anaerobically or aerobically treated wastewater is pumped from the bottom of a septic tank into the opening 84 of the first U shaped compartment of the Ozone Contactor Assembly and comes into contact with the dedicated supply of ozone for the first chamber. The positive pressure from the pump forces the wastewater from one U shaped chamber and its dedicated supply ozone into the next U shaped chamber with its dedicated supply of ozone and, finally, into either the system discharge pipe or back into the septic tank compartment for subsequent treatment with ozone.

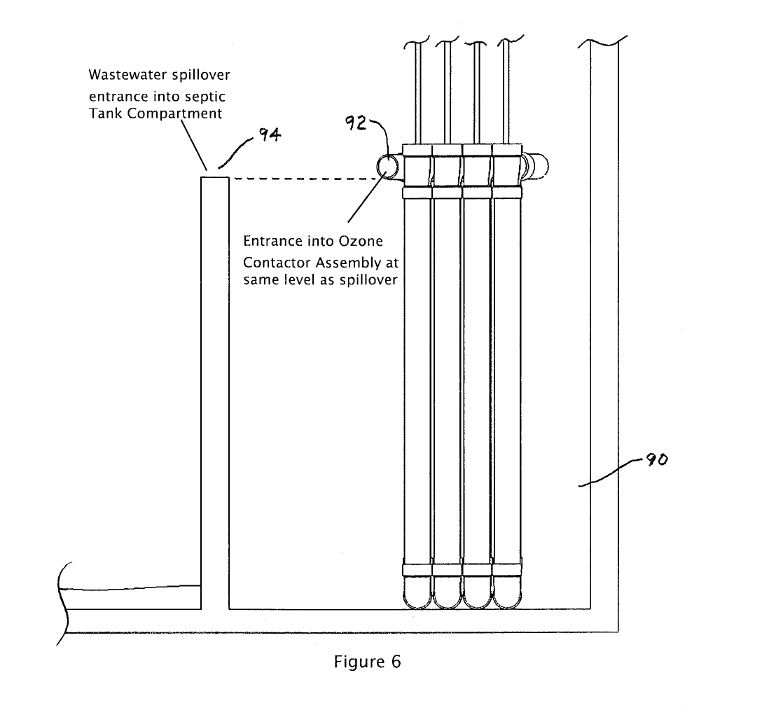

In another embodiment, shown in FIG. 6, the aforementioned Ozone Contactor Assembly is constructed and installed into a septic tank compartment 90 so that the wastewater entrance 92 into the Ozone Contactor Assembly is at the same level as the wastewater spillover entrance 94 into the septic tank compartment 90. With this system, as wastewater flows into the septic tank compartment 90, it also flows into the Ozone Contactor Assembly via gravity, eliminating the need for a pump.

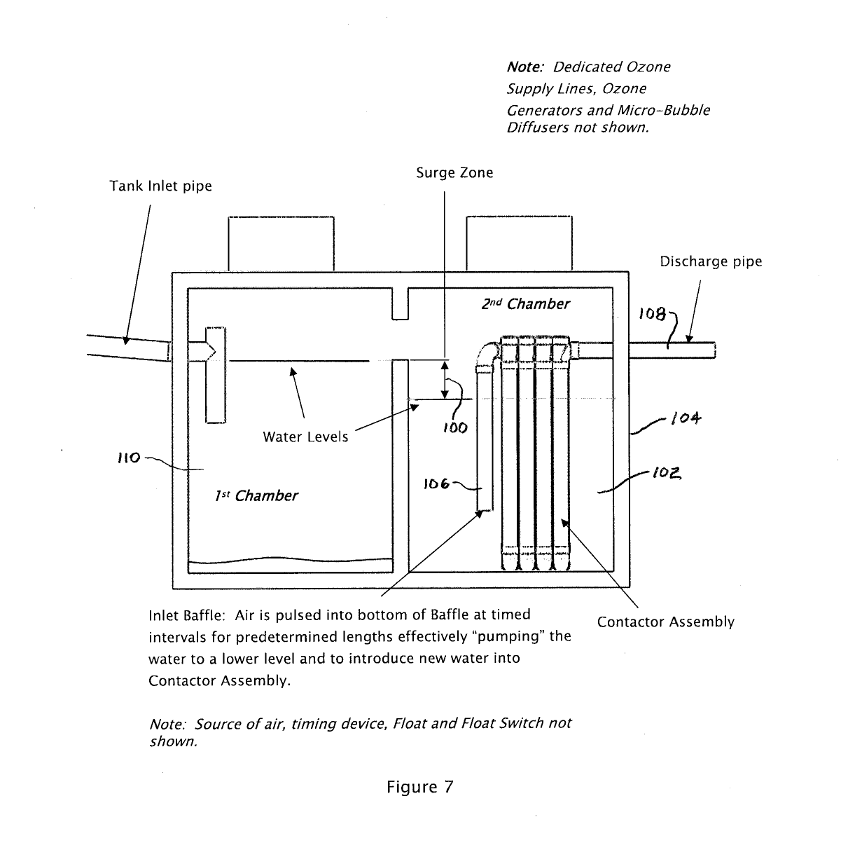

In another embodiment, shown in FIG. 7, a surge or buffer zone 100 is created in the second chamber 102 of a septic tank 104. In this embodiment, the Ozone Contactor Assembly is constructed and installed into the septic tank 104 with an Inlet Baffle 106 replacing the pump in the afore mentioned embodiment of FIGS. 4 and 5. Compressed air from an air pump (not shown) is introduced into the Inlet Baffle 106 of the Ozone Contactor Assembly. The compressed air rises within the Inlet Baffle 106, displacing water within the Ozone Contactor Assembly and forcing it out of the discharge pipe 108 of the Ozone Contactor Assembly and out of the septic tank 104. A float and float switch (not shown) along with a programmable electronic timing device (not shown) are used to initiate and control the timing and frequency of compressed air surges, which controls the water level in the second chamber 102. Generally, the water level in the second chamber 102 is lower with respect to the first chamber 110, creating a surge or buffer zone 100 that will allow surges of septic water into the tank 104 at peak usage hours without discharging any untreated water out of the tank 104. With this system, a predictable and repeatable treatment time for the wastewater is ensured which, as a result, produces a consistently treated outflow. It should be understood that the buffer zone can be created in a variety of ways, including by using appropriate float switches and pumps or valve for maintaining the level of fluid in the second chamber lower than its inlet.

1. A wastewater treatment system comprising:
a first chamber adapted to receive wastewater and being arranged to perform a first treatment process;
a second chamber positioned to receiving wastewater from the first chamber and including an ozone contactor assembly that infuses ozone into the second chamber and produces treated water; and
a storage tank positioned to receive treated water from the second chamber and hold it for re-use.

2. A wastewater treatment as claimed in claim 1, wherein the ozone contactor assembly comprises:
a conduit having an intake adapted to receive wastewater and a discharge adapted to deliver wastewater; and
an ozone generator positioned to provide ozone to the conduit.

3. A wastewater treatment as claimed in claim 2, wherein the conduit includes a downwardly-angled portion and an upwardly-angled portion coupled between the intake and the discharge, and wherein the ozone generator is positioned to provide ozone to a lower portion of the conduit.

4. A wastewater treatment as claimed in claim 2, wherein the conduit is a substantially U-shaped conduit.

5. A wastewater treatment as claimed in claim 2, wherein the downwardly-angled portion and the upwardly-angled portion are each substantially vertically-oriented.

6. A wastewater treatment as claimed in claim 2, wherein the ozone generator includes at least one diffuser in a bottom portion of each of the downwardly-angled portion and the upwardly-angled portion.

7. A wastewater treatment as claimed in claim 2, wherein the conduit is a first conduit, the intake is a first intake, the discharge is a first discharge, the downwardly-angled portion is a first downwardly-angled portion, and the upwardly-angled portion is a first upwardly-angled portion, and wherein the assembly further includes a second conduit having:
a second intake positioned to receive wastewater from the first discharge;
a second discharge; and
a second downwardly-angled portion and a second upwardly-angled portion coupled between the second intake and the second discharge, wherein the ozone generator is positioned to provide ozone to a lower portion of the second conduit.

8. A wastewater treatment system as claimed in claim 7, wherein the ozone generator includes at least one diffuser at a lower portion of each of the first and second conduits.

9. An ozone treatment device as claimed in claim 7, wherein the ozone generator includes at least one diffuser in each of the first downwardly-angled portion, the first upwardly-angled portion, the second downwardly-angled portion, and the second upwardly-angled portion.

10. An ozone contactor assembly comprising:
a conduit having an intake adapted to receive wastewater and a discharge adapted to deliver wastewater; and
an ozone generator positioned to provide ozone to the conduit.

11. An ozone contactor assembly as claimed in claim 10, wherein the conduit includes a downwardly-angled portion and an upwardly-angled portion coupled between the intake and the discharge, and wherein the ozone generator is positioned to provide ozone to a lower portion of the conduit.

12. An ozone contactor assembly as claimed in claim 11, wherein the conduit is a substantially U-shaped conduit.

13. An ozone contactor assembly as claimed in claim 11, wherein the downwardly-angled portion and the upwardly-angled portion are each substantially vertically-oriented.

14. An ozone contactor assembly as claimed in claim 11, wherein the ozone generator includes at least one diffuser in a bottom portion of each of the downwardly-angled portion and the upwardly-angled portion.

15. An ozone contactor assembly as claimed in claim 11, wherein the conduit is a first conduit, the intake is a first intake, the discharge is a first discharge, the downwardly-angled portion is a first downwardly-angled portion, and the upwardly-angled portion is a first upwardly-angled portion, and wherein the assembly further includes a second conduit having:
a second intake positioned to receive wastewater from the first discharge;
a second discharge; and
a second downwardly-angled portion and a second upwardly-angled portion coupled between the second intake and the second discharge, wherein the ozone generator is positioned to provide ozone to a lower portion of the second conduit.

16. An ozone contactor assembly as claimed in claim 15, wherein the first and second conduits are substantially U-shaped conduits.

17. An ozone contactor assembly as claimed in claim 15, wherein the first downwardly-angled portion, the first upwardly-angled portion, the second downwardly-angled portion, and the second upwardly-angled portion are each substantially vertically-oriented.

18. An ozone contactor assembly as claimed in claim 15, wherein the ozone generator includes at least one diffuser at a lower portion of each of the first and second conduits.

19. An ozone contactor assembly as claimed in claim 15, wherein the ozone generator includes at least one diffuser in each of the first downwardly-angled portion, the first upwardly-angled portion, the second downwardly-angled portion, and the second upwardly-angled portion.

20. An ozone contactor assembly as claimed in claim 15, wherein the first intake is substantially at the same level as the second discharge.
